(19) United States
(12) Patent Application Publication
(10) Pub. No.: US 2008/0247342 A1
(43) Pub. Date: Oct. 9, 2008

(54) Connection Setup for the Exchange of Data of an Ip-Based Service

(75) Inventors: Martin Gugerell, Wien (AT); Heinrich Huber, Wien (DE); Erwin Postman, Forchtenstein (AT); Ulrich Weiss, Munchen (DE)

Correspondence Address: BELL, BOYD & LLOYD, LLP, P.O. BOX 1135, CHICAGO, IL, 60690, US

(73) Assignee: Siemens Aktiengesellschaft, Munchen (DE)

(21) Appl. No.: 11/630,265

(22) PCT Filed: Jun. 20, 2005
(86) PCT No.: PCT/EP2005/052846

§ 371 Date: May 21, 2008

(30) Foreign Application Priority Data
Jun. 23, 2004 (DE) 10 2004 030 290.1

(51) Int. Cl. H04B 7/00

(52) U.S. Cl. 370/310

(57) ABSTRACT

The invention relates to a method and a device for setting up a connection between a terminal (MS) in a communication network and a network element (AS, IPU) in an IP network for exchanging data of an IP-based service. The invention is characterized by setting up a connection between at least one network unit (OSUS-Proxy) of the communication network and the terminal (MS) of the communication network for exchanging data of an IP-based service comprising at least one signaling message. The at least one network unit (OSUS-Proxy) of the communication network, in accordance with the content of the at least one signaling message by the terminal (MS), sets up a connection for exchanging data of an IP-based service with the network element (AS, IPU) of the IP network with at least one recipient-specific signaling. Once both connections are set up, the at least one network unit (OSUS-Proxy) of the communication network forwards received data of an IP-based service from the network element (AS, IPU) to the terminal (MS) and from the terminal (MS) to the network element (AS, IPU).

The invention relates to a method and a device for setting up a connection between a terminal in a communication network and a network element in an IP network for exchanging data of an IP-based service.

The Internet or an IP network has fundamentally changed how information and information procurement are handled. Mobile technology or a cellular mobile radio network has significantly influenced the manner of communications. The so-called IP Multimedia Subsystem was introduced in order to integrate the potential of the Internet into mobile communications. This is defined in the specification 3GPP TS 23.228. The IP Multimedia Subsystem (IMS) introduces a new technology for connecting different networks and makes possible new concepts for mobile services, such as data, text, voice and/or video services for example. The so-called Session Initiation Protocol (SIP) is generally used for the communication. The Session Initiation Protocol SIP is a text-based signaling protocol for Internet conferencing, telephony, conveyance of presence information for a user, event notification, instant messaging (messaging services) and many other fields of application. With the ITU H.323 protocol, it is one of the two standards for the signaling and control of Internet telephony (Voice over Internet Protocol—VOIP). The development of SIP is directed by the IESG, the Internet Engineering Steering Group within the IETF. SIP has a central significance in the IP Multimedia Subsystem. It is used wherever users of a terminal need to be localized and sessions need to be set up, checked, modified and terminated in the system. In this situation, it interoperates closely with the Session Description Protocol (SDP) which serves to describe the multimedia sessions. It was presented for the first time in RFC 2543 published in 1999 and has been re-specified in the currently valid specification RFC 3261 published in 2002. To accompany the protocol, many RFCs with SIP-related aspects and extensions have been published by the IETF since 1999, dealing with topics such as bandwidth protection (Quality of Service—QoS), media authorization, private sphere, DHCP etc.

The object of the invention consists in proposing a cost-effective and efficient capability for connection with IP-based services.

The object is achieved according to the invention by the subject matter of the independent claims. Developments of the invention are set down in the subclaims.

A core of the invention consists in the fact that a terminal of a communication network sets up a connection with at least one network unit of the communication network using at least one signaling message. In this situation, a terminal can be a mobile radio terminal, a mobile computer, a mobile organizer, a fixed-network terminal etc. of a communication network, such as for example a cellular mobile radio network, a fixed network (PSTN, ISDN, Enterprise), a packet-switched communication network (xDSL, GPRS, WLAN, WiMax etc.) etc. The at least one network unit of the communication network behaves like a proxy server in this situation. A proxy server generally acts on behalf of another. In connection with the Internet, this refers to a server which is charged by the browser (client or terminal) with fetching data of a service from a server in an IP network (Internet). The proxy server then transfers the data of the service to the client as if it were the actual web server. The proxy server uses the requests from the client to decide on which server the desired data is to be found, fetches the data from this server and passes it to the client. Ideally, a connection with SIP signaling is set up between the terminal and the at least one network unit. To this end, the terminal must have at its disposal a so-called SIP User Agent or an IMS client in order to enable support for SIP and access to the IP Multimedia Subsystem. Naturally, other types of signaling, such as for example H.323, an MNO (Mobile Network Operator or communication network operator) specific or other signaling are conceivable for the method according to the invention. According to the content of the at least one signaling message from the terminal the at least one network unit sets up a connection to the network element in the IP network with at least one recipient-specific signaling, which makes available the IP-based service desired by the terminal. The signaling which the network element supports for the exchange of data of an IP-based service is used as recipient-specific signaling. Such an IP-based application signaling protocol (recipient-specific signaling) can for example be an http (Hypertext Transfer Protocol), an ftp (File Transfer Protocol), an SMTP (Simple Mail Transfer Protocol) etc. Naturally, recipient-specific signalings, such as for example SIP signaling, H.323, an MNO (Mobile Network Operator or communication network operator) specific or other signaling are also conceivable for the method according to the invention. The network element can for example be an application server (AS) on which the IP-based service desired by the terminal can be fetched, an IP telephone (IPU), a computer or any other network element of the IP network that offers an IP-based service. The signaling message could for example contain the IP address of the network element which provides the IP-based service. A further alternative according to the invention could consist in the fact that after the terminal has successfully set up a connection with the at least one network unit of the communication network, the terminal of the at least one network unit sends a connection setup request using the recipient-specific signaling in order to set up a connection between the at least one network unit and the network element of the IP network. In this case also the terminal must naturally have a corresponding functionality in order to be able to handle or process recipient-specific signalings. When both connections have been set up, the at least one network unit forwards data of an IP-based service from the network element to the terminal and from the terminal to the network element.

One advantage of the invention consists in the fact that it makes possible a standardized method for all IP-based services (non-native IMS and native IMS services) by way of the IMS.

The invention is described in more detail below with reference to an embodiment illustrated in the figures. In the drawings:

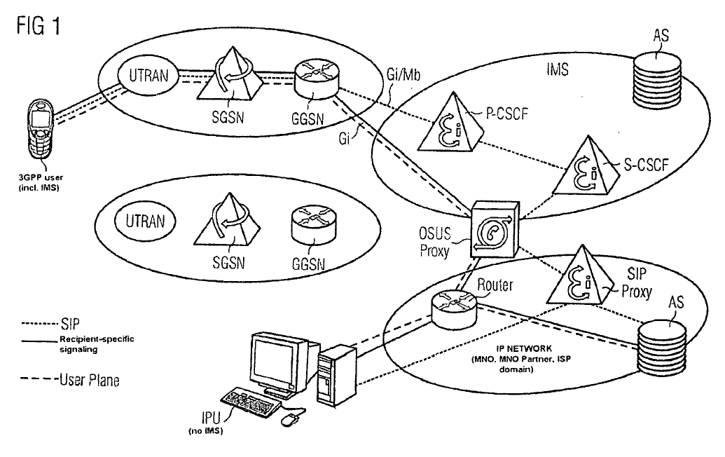

FIG. 1 shows the connection setup with a network element for exchanging data of an IP-based service if the network element supports signaling with SIP,

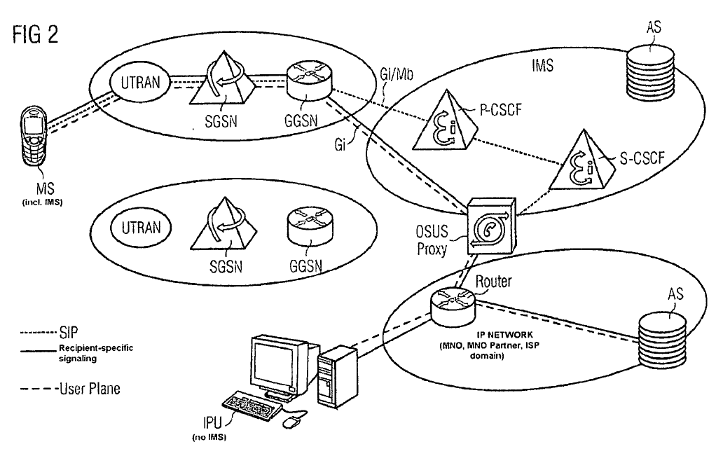

FIG. 2 shows the connection setup with a network element for exchanging data of an IP-based service if the network element does not support signaling with SIP,

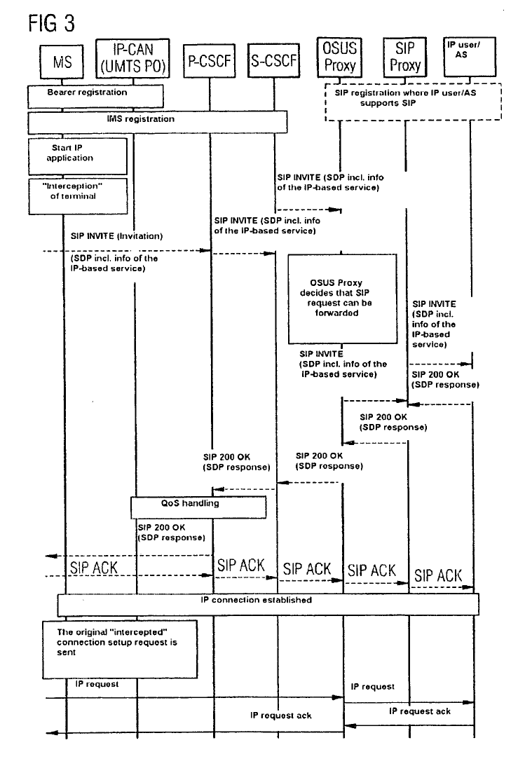

FIG. 3 shows the information flow for the example according to FIG. 1,

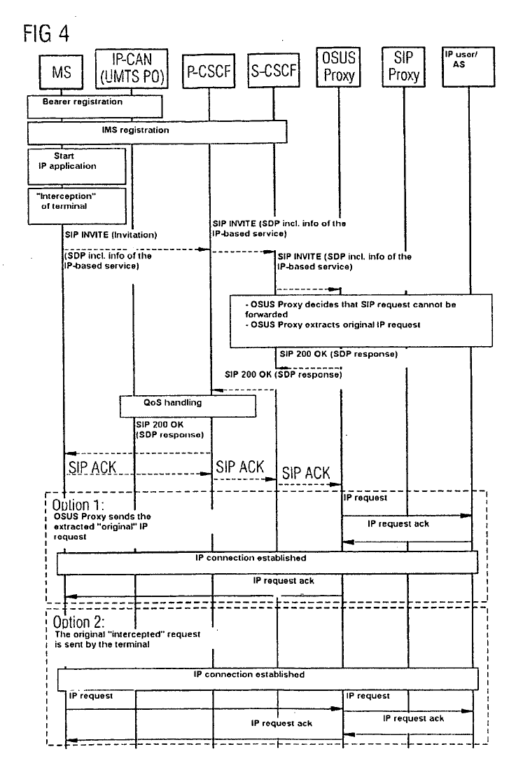

FIG. 4 shows the information flow for the example according to FIG. 2,

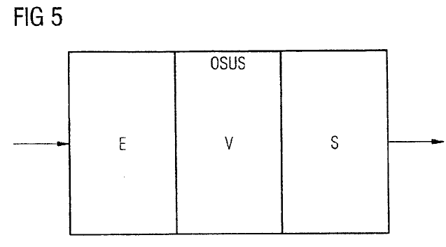

FIG. 5 shows a device according to the invention.

FIG. 1 shows a simplified network architecture for the setup of a connection between a terminal MS in a communication network and a network element AS, IPU in an IP network for exchanging data of an IP-based service, using least one SIP signaling message. In this situation, signaling messages are exchanged between the terminal MS and the network element AS, IUP by way of the access network UTRAN, Serving GPRS Support Node SGSN, Gateway GPRS Support Node GGSN, by way of the IP Multimedia Subsystem IMS with a Proxy Call State Control Function P-CSCF and a Serving Call State Control Function S-CSCF, a network unit OSUS Proxy of the communication network and by way of a SIP Proxy SIP-P. The network unit OSUS Proxy (Operator Specific User Service) behaves here like a proxy server. In this situation, the network unit OSUS Proxy supports the functionalities of the SIP User Agent, thereby enabling a connection to be set up by means of SIP signaling between the terminal MS and the network unit OSUS Proxy. If the connection is established with the aid of SIP signaling, the signaling can take place using a recipient-specific signaling, such as for example http, ftp etc., for the exchange of data of the IP-based service requested by the terminal MS. When both connections have been established, the network unit OSUS Proxy forwards data of an IP-based service from the terminal MS to the network element AS, IUP and from the network element AS, IUP to the terminal MS.

FIG. 2 shows a simplified network architecture for the setup of a connection between a terminal MS in a communication network and a network element AS, IPU in an IP network for exchanging data of an IP-based service in the event that the network element AS, IUP does not support SIP signaling. In this case, SIP signaling messages are exchanged between a terminal MS and a network unit OSUS Proxy by way of the access network UTRAN, Serving GPRS Support Node SGSN, Gateway GPRS Support Node GGSN, by way of the IP Multimedia Subsystem IMS with a Proxy Call State Control Function P-CSCF and a Serving Call State Control Function S-CSCF, and a connection is thus set up. For reasons of simplicity, in this example only one network unit OSUS Proxy is used for executing the method according to the invention. Naturally, a plurality of network units OSUS Proxy could also execute the method according to the invention. The network unit OSUS Proxy then uses a recipient-specific signaling to set up a connection to the network element in the IP network for exchanging data of an IP-based service. In general, the network unit OSUS Proxy can be a separate network unit OSUS Proxy of the communication network or can be integrated in a further network unit of the communication network.

FIG. 3 shows the information flow for the example accordingly to FIG. 1. Firstly, the user of a terminal MS starts an IP-based application or a user program, such as for example an Internet browser, an FTP client, a P2P service etc. on his terminal MS. Then a SIP connection is set up by the terminal MS to the network unit OSUS Proxy. The SIP request contains the recipient-specific signaling request (http, ftp etc.) for provision of an IP-based service on a network element AS, IPU with the SDP part (Session Description Protocol) of the SIP invitation message (SIP-INVITE). This connection setup request is sent by way of the IP Multimedia Subsystem IMS with the two network nodes P-CSCF (Proxy Call State Control Function) and S-CSCF (Serving Call State Control Function) to the network unit OSUS Proxy. The network unit OSUS decides on the basis of the analysis of the SDP contents of the SIP invitation message whether the connection setup request can be forwarded to the network element AS, IPU in the IP network. In the event that the network element AS, IPU supports the SIP signaling but not the 3GPP SIP profile, the network unit OSUS Proxy can act like a so-called B2BUA (Back to Back User Agent). This user agent (B2BUA) is defined in the specification 3GPP TR 29.962 “Signaling interworking between the 3GPP profile of the Session Initiation Protocol (SIP) and non-3GPP SIP usage”. If the network element AS, IPU possesses a SIP user agent, the SIP connection setup request is forwarded to the network element AS, IPU. Both SIP user agents, in the terminal MS and in the network element AS, IPU, set up a connection for exchanging data of the IP-based service, as defined in the SDP part of the SIP invitation message. The setting up of this connection between these two end points (terminal MS and network element AS, IPU) thus occurs through the connection setup process, as it is defined for the IP Multimedia Subsystem. When the connection has been set up, the recipient-specific signaling request is sent to the network element AS, IPU. If the IP-based service is a client-to-client service, the same connection setup process can be used. Alternatively, the network element AS, IPU can also begin the communication directly with the recipient-specific signaling. In this situation, the network unit OSUS Proxy acts as a proxy server, in other words it (OSUS Proxy) forwards the received data of an IP service from the network element AS, IPU to the terminal MS and from the terminal MS to the network element AS, IPU.

FIG. 4 shows the information flow for the example according to FIG. 2. In this case, the network element AS, IPU of the IP network has no SIP user agent at its disposal, in other words the network element cannot support the SIP signaling. In this situation, the network unit OSUS Proxy deals with the SIP invitation message from the terminal MS and acts as an end point for this connection. The SIP connection (SIP session) between network unit OSUS Proxy and terminal MS is set up by .means of the SIP invitation message (SIP Invite) from the terminal MS, the SIP 200 OK message (response to the SIP Invite) from the network unit OSUS and the SIP acknowledgment message (SIP ACK) from the terminal MS. In the individual SIP messages a description is transported, which is defined by SDP (Session Description Protocol) in the SIP signaling, of the connection to be set up or the IP-based service desired by the terminal. The IP Multimedia Subsystem IMS with its network nodes P-CSCF, S-CSCF mentioned under FIG. 2 routes the SIP messages from the terminal MS to the network unit OSUS Proxy and vice versa, and thereby assumes control of the connection (Session Control). The network unit OSUS Proxy thus receives all the necessary information for setting up a connection between the terminal MS and the network unit OSUS Proxy. This could occur for example by means of a second (secondary) PDP context. On the basis of internal data, not described in more detail in this application, the network unit decides that the SIP connection setup request cannot be forwarded from the terminal MS to the receiver network element AS, IPU. For this purpose, the network unit generates a corresponding request with a recipient-specific signaling, based on the content of the SIP messages received from the terminal MS, and sends this request to the network element AS, IPU. The network unit OSUS Proxy analyzes the content of the SIP messages from the terminal MS, for example the request contained for the application or user program to set up a connection with the network element AS, IPU for exchanging data of the desired IP-based service and uses the recipient-specific signaling, in other words the signaling that the network element AS, IPU is able to support, such as for example http, ftp etc., for setting up a connection with the network element AS, IPU. The response from the network element AS, IPU is forwarded to the terminal MS. For the further communication or for the exchange of data of an IP service, the network unit OSUS Proxy acts as a proxy server. The network unit OSUS Proxy thus forwards the received data of an IP service from the network element AS, IPU to the terminal MS and from the terminal MS to the network element AS, IPU. Alternatively, the corresponding request can also be generated by the terminal MS with a recipient-specific signaling for the connection setup and sent by way of the network unit OSUS Proxy to the network element AS, IPU. Here too the network unit acts as a proxy server.

FIG. 5 shows a device for executing the method according to the invention as has been described in FIG. 4, whereby the device uses a send unit S and a receive unit E of the network unit OSUS Proxy for mobile communication with the terminal MS and the network element AS, IPU of the IP network, a processing unit V for setting up a connection between a network unit OSUS Proxy of the communication network and the terminal MS of the communication network for exchanging data of an IP-based service with at least one signaling message, for setting up a connection for exchanging data of an IP-based service between the network unit OSUS Proxy of the communication network and the network element AS, IPU of the IP network according to the content of the at least one signaling message from the terminal MS with at least one recipient-specific signaling and for forwarding received data of an IP-based service from the network element AS, IPU to the terminal MS and from the terminal MS to the network element AS, IPU after setup of both connections.

1. A method for setting up a connection between a terminal (MS) in a communication network and a network element (AS, IPU) in an IP network for exchanging data of an IP-based service,
Characterized in that
a connection for exchanging data of an IP-based service with at least one signaling message is set up between at least one network unit (OSUS Proxy) of the communication network and the terminal (MS) of the communication network,
according to the content of the at least one signaling message from the terminal (MS) the at least one network unit (OSUS Proxy) of the communication network sets up a connection for exchanging data of an IP-based service with the network element (AS, IPU) of the IP network with at least one recipient-specific signaling,
after both connections have been set up the at least one network unit (OSUS Proxy) of the communication network forwards received data of an IP-based service from the network element (AS, IPU) to the terminal (MS) and from the terminal (MS) to the network element (AS, IPU), and
the network unit (OSUS Proxy) of the communication network determines the recipient-specific signaling to be used for signaling the connection setup to the network element (AS, IPU) of the IP network on the basis of the SDP content of the SIP invitation.

2. The method as claimed in claim 1, characterized in that
after both connections have been set up between the terminal (MS) and the at least one network unit (OSUS Proxy) and between the at least one network unit (OSUS Proxy) and the network element (AS, IPU) a recipient-specific protocol is used for exchanging data of the IP service between the terminal (MS) and the network element (AS, IPU).

3. The method as claimed in one of the preceding claims, characterized in that
after the setup of the connection with the at least one network unit (OSUS Proxy) the terminal (MS) of the communication network makes a connection setup request to set up a connection with the network element (AS, IPU) of the IP network with at least one recipient-specific signaling to the network unit (OSUS Proxy).

4. The method as claimed in one of the preceding claims, characterized in that
a SIP signaling message, an H.323 signaling message and/or a mobile network operator (MNO) specific signaling message is used as the signaling message between the terminal (MS) and the at least one network unit (OSUS Proxy) in the communication network.

5. The method as claimed in one of the preceding claims, characterized in that
the at least one network unit (OSUS Proxy) of the communication network is a proxy server.

6. The method as claimed in one of the preceding claims, characterized in that
the communication network is a cellular mobile radio network, a packet-switched communication network and/or a fixed network.

7. The method as claimed in one of the preceding claims, characterized in that
the terminal (MS) is a mobile radio terminal, a fixed-network terminal, a mobile computer and/or a mobile organizer.

8. The method as claimed in one of the preceding claims, characterized in that
the at least one network element (OSUS Proxy) in the IP network is an IP telephone terminal, a computer and/or an application server.

9. The method as claimed in one of the preceding claims, characterized in that
the recipient-specific signaling is an IP-based application signaling protocol.

10. The method as claimed in one of the preceding claims, characterized in that
an http protocol, an ftp protocol, an SMTP protocol, an H.323 signaling, a SIP signaling and/or a mobile network operator specific signaling is used as the recipient-specific signaling.

11. A device for setting up a connection between a terminal (MS) in a communication network and a network element (AS, IPU) in an IP network for exchanging data of an IP-based service,
with a send unit (S) and a receive unit (E) of the at least one network unit (OSUS Proxy) for mobile communication with the terminal (MS) and the network element (AS, IPU) of the IP network,
with a processing unit (V) for setting up a connection between at least one network unit (OSUS Proxy) of the communication network and the terminal (MS) of the communication network for exchanging data of an IP-based service with at least one signaling message,
with the processing unit (V) for determining the recipient-specific signaling to be used for signaling the connection setup to the network element (AS, IPU) of the IP network on the basis of the SDP content of the SIP invitation,
with the processing unit (V) for setting up a connection for exchanging data of an IP-based service between the at least one network unit (OSUS Proxy) of the communication network and the network element (AS, IPU) of the IP network according to the content of the at least one signaling message from the terminal (MS) with the at least one recipient-specific signaling
with the processing unit (V) for forwarding received data of an IP-based service from the network element (AS, IPU) to the terminal (MS) and from the terminal (MS) to the network element (AS, IPU) after setup of both connections.

12. The device as claimed in claim 11, characterized in that
the at least one network unit (OSUS Proxy) of the communication network is a proxy server.

13. The device as claimed in claims 11 and 12, characterized in that
the terminal (MS) is a mobile radio terminal, a fixed-network terminal, a mobile computer and/or a mobile organizer.

14. The device as claimed in claims 11 to 13, characterized in that
the network element (AS, IPU) in the IP network is an IP telephone terminal, a computer and/or an application server. 0
